(19) United States
(12) Patent Application Publication
(10) Pub. No.: US 2024/0165873 A1
(43) Pub. Date: May 23, 2024

(54) PART FEATURES AND SPECIFIC PRINT MODES

(71) Applicant: Hewlett-Packard Development Company, L.P., Spring, TX (US)

(72) Inventors: Sergio GONZALEZ MARTIN, Sant Cugat del Valles (ES); Ismael FERNANDEZ AYMERICH, Sant Cugat del Valles (ES); Manuel FREIRE GARCIA, Sant Cugat del Valles (ES); Pablo DOMINGUEZ PASTOR, Sant Cugat del Valles (ES)

(21) Appl. No.: 18/283,792

(22) PCT Filed: Mar. 29, 2021
(86) PCT No.: PCT/US2021/024690

§ 371 Date: Sep. 23, 2023

(51) Int. Cl. B29C 64/171; A46D 3/00; B29C 64/393; B29L 31/42; B33Y 10/00; B33Y 50/02; B33Y 80/00

(52) U.S. Cl. CPC B29C 64/171; A46D 3/00; B29C 64/393; B33Y 10/00; B33Y 50/02; B33Y 80/00; B29L 2031/42

(57) ABSTRACT

Examples include a method implemented in a three dimensional printing system wherein a print job comprising a plurality of parts to be printed is received. A part feature intended to be printed in a specific print mode is identified, wherein the specific print mode is customized for the part feature. The print job is executed using the specific print mode for the part feature. The use of the specific print mode is monitored.

### BACKGROUND

This disclosure generally relates to a printing system that allows printing three dimensional objects. Three dimensional objects may be generated for example through treatment of a build material.

### BRIEF DESCRIPTION OF THE DRAWINGS

Various example features will be apparent from the detailed description which follows, taken in conjunction with the accompanying drawings, wherein:

FIG. 1 is a block diagram of an example method;

FIG. 2 is a block diagram of another example method;

FIG. 3 is a block diagram of another example method;

FIG. 4 is a block diagram of another example method;

FIG. 5 is a block diagram of another example method;

FIG. 6 is a block diagram of another example method;

FIG. 7 is a block diagram of another example method;

FIG. 8 is a block diagram of another example method;

FIG. 9 is a schematic illustration of an example of a print job which can be produced by a 3D printing system;

FIG. 10 is a schematic illustration of another example of a print job which can be produced by a 3D printing system; and

FIG. 11 is a block diagram of an example printing system controller for an example 3D printing system.

### DETAILED DESCRIPTION

Three dimensional (3D) printing systems may generate three dimensional parts by treating layers of build material. For example, treatment may comprise one or more of extruding the build material, applying energy to the build material, ejecting a binder agent, fusing agent and/or detailing agent onto the build material. The properties of generated parts may depend on the type of build material, the type of treatment mechanism and the type of method used.

The 3D printing system may generate parts based on structural design data. This may involve a designer determining a three dimensional model of parts to be generated, for example using a computer aided design (CAD) application. The model may define the solid portions of the parts. The designer may group a plurality of parts into a print job, which is to be executed by the 3D printing system during a build process. In some examples, the print job may be processed to define slices or parallel planes of the print job. Each slice may define a portion of a respective layer of build material that is to be solidified or caused to coalesce by the 3D printing system. In some examples, the build material is a powder-like granular material, which may for example be a plastic, ceramic or metal powder. Build material may be deposited on a print bed and processed layer by layer, for example within a build area.

In some examples, selective treatment is achieved through directional application of energy, for example using a laser or electron beam which results in solidification of build material where the directional energy is applied. In other examples, at least one print agent may be selectively applied to the build material layer and may be liquid when applied. For example, a fusing agent (also termed ‘coalescence agent’ or ‘coalescing agent’) may be selectively distributed onto portions of a layer of build material in a pattern derived from data representing a slice of the three dimensional part to be printed. The fusing agent may have a composition which absorbs energy such that, when it is applied to the layer, the build material to which it has been applied heats up, coalesces and solidifies. Upon cooling, a slice of the three-dimensional part is formed in accordance with the pattern. In other examples, coalescence may be achieved in other manners.

In addition to the fusing agent, in some examples, a print agent may comprise a detailing agent, which acts to modify the effects of the fusing agent. For example, the detailing agent may act to reduce or increase coalescence, or assist in producing a particular finish or appearance to an object. In some examples, the detailing agent may be applied near an edge surface of a part being printed, for example to reduce coalescence.

However, some parts of the print job may comprise features which are to be treated differently from the rest of the part during the execution of the print job. For example, some features may have certain physical properties which can be affected by the print agents used. In such cases, a specific print mode may be defined to enable the 3D printing system to generate the features. A print mode may define how the 3D printing system operates to generate parts, and a specific print mode may enable the 3D printing system to operate differently from a standard print mode. The specific print mode may contribute to the features being treated differently, for example by applying different print parameters for producing the features. The use of the specific print mode may contribute to the features being formed as intended or to present particular intended properties.

The specific print mode may improve the quality of the parts produced from the print job. However, in some examples, using the specific print mode may increase print time, for example if using the specific print mode is slower than using the standard print mode. In some examples, using the specific print mode may increase the resources used by the 3D printing system, such as one or more of the amount of build material and the amount of print agent. Further, the cost of using the specific print mode may be higher than that of using the standard print mode.

The present disclosure proposes to identify part features which are intended to be printed in the specific print mode and generate these features using the specific print mode. Thus, parts may be formed as intended with reduced or limited impact on part yield and with controlled resource consumption rates. In addition, the present disclosure proposes to monitor the usage of the specific print mode. Thus, operators may accurately track the amount of resources used, such as print agent and build material. Further, the cost associated with using the specific print mode may be determined as a function of the usage of the specific print mode, which may provide cost saving benefits.

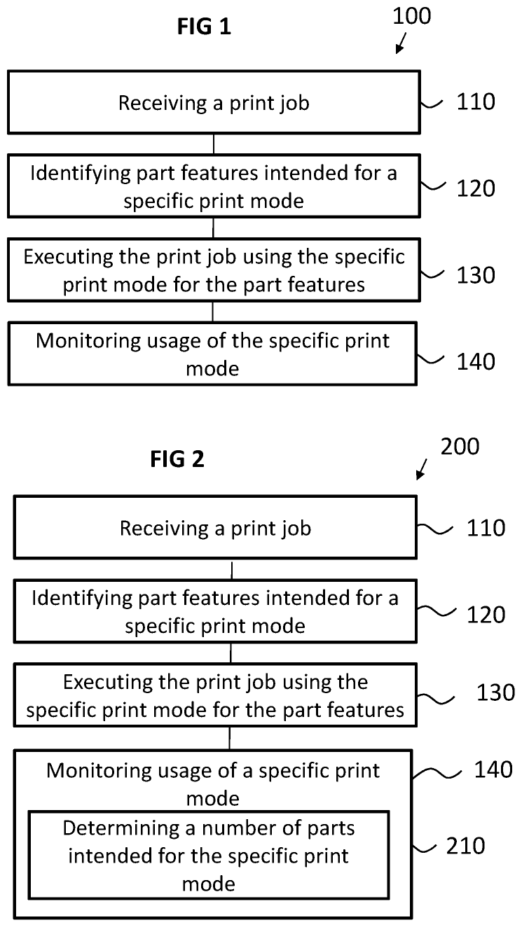

FIG. 1 illustrates an example method 100 for monitoring the usage of the specific print mode.

Method 100 comprises, at block 110, receiving a print job. The print job may comprise a plurality of parts which may have been generated by a designer using a CAD application. The parts of the print job are those that the designer intends to print using the 3D printing system during a build process. The print job can for example be a Computer Aided Design (CAD) model, or a Stereolithographic (STL) data file. The print job may comprise a plurality of parts of different geometric shapes, or a plurality of the same part. The plurality of parts may increase part yield, for example by enabling a high number of parts to be printed in a single build process. In some examples, the number of parts comprised in the print job may be determined according to the available space within the build area.

Method 100 comprises, at block 120, identifying a part feature intended to be printed in the specific print mode. As mentioned above, a part may present features which are to be printed differently from the rest of the part. Part features may for example be one or more from a list comprising: small features, features intended to present a desired flexibility, a desired dimensional accuracy, a desired external surface cleanliness, a desired rugosity, a desired color and any other physical property which differs from the rest of the part. Identifying these features enables them to be produced using the specific print mode, which may be customized for these features. In some examples, the specific print mode may comprise print parameters for the 3D printing system which differ from those used for the rest of the part, enabling them to be formed as intended or formed to present particular intended properties. In some examples, the print parameters may comprise one or more from a list comprising: a quantity of print agent, a distribution of print agents, a layer thickness, a heating temperature, a build material choice, a print agent extrusion speed or another parameter that may be used by the 3D printing system to generate the parts. In some examples, other part features, or other parts, of the same print job, are intended to be printed in another print mode, the other print mode differing from the specific print mode. In some examples, the other part features or other parts may be printed in a standard print mode.

Method 100 comprises, at block 130, executing the print job. The 3D printing system may produce the parts of the print job by treating layers of a build material. As mentioned above, the treatment of build material may comprise the application of one or more of energy and/or one or more print agents onto a layer of build material. The treatment mechanism may be dependent on the print parameters used to operate the 3D printing system and may influence the physical properties imparted to the printed parts. Thus, the 3D printing system may use the specific print mode for producing the features identified at block 120 to ensure that they are successfully built and present intended properties. The 3D printing system may alternate between print modes while executing the print job. In some examples, the 3D printing system may operate according to the standard print mode and switch to the specific print mode for producing part features intended for the specific print mode.

Method 100 also comprises, at block 140, monitoring the usage of the specific print mode. For example, monitoring the usage of the specific print mode may be achieved by determining a number of parts comprising a part feature intended to be printed in the specific print mode or timing the use of the specific print mode. Monitoring the usage of the specific print mode may ensure that the specific print mode is used for features intended to be produced in the specific print mode. In some examples, information on the usage of the specific print mode may improve management of the operation of the 3D printing system. In some examples, operators may accurately track resources used for producing the parts. For example, operators may be provided with detailed insight on the volume of print agent used to execute the print job. In some examples, information on the usage of the specific print mode may provide cost saving benefits. For example, the cost of the specific print mode may be determined proportionally to, or in function of, its usage.

FIG. 2 illustrates another example method 200. Method 200 comprises blocks 110, to 140 as described in the context of method 100.

In this example method 200, block 140 of monitoring the usage of the specific print mode comprises, at block 210, determining a number of parts comprising a part feature intended to be printed in the specific print mode. In some examples, determining the number of parts comprises counting the number of parts for which the specific print mode is used. In some examples, determining the number of parts may occur when identifying features intended to be produced in the specific print mode. In some examples, determining the number of parts may occur during production of the parts by the 3D printing system. Other examples of monitoring the usage of the specific print mode may include timing the use of the specific print mode during the production of the parts by the 3D printing system.

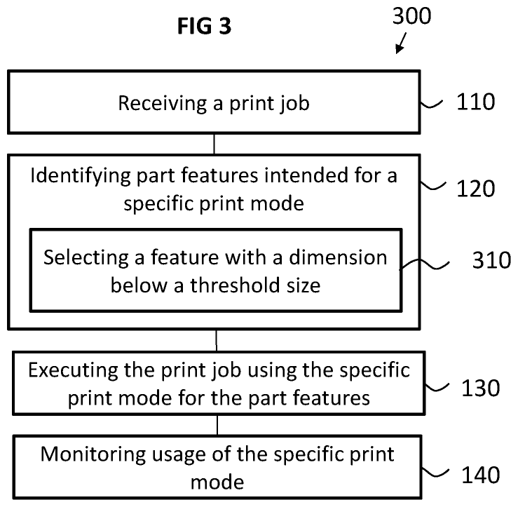

FIG. 3 illustrates another example method 300. Method 300 comprises blocks 110 to 140 as described in the context of method 100. In another example method (not represented here), method 300 may also comprise block 210 of method 200.

In this example method 300, block 120 of identifying the part features comprises, at block 310, selecting a feature with a dimension below a threshold size. In such examples, features intended to be printed in the specific print mode are features of less than a threshold size. A threshold size may for example be a dimension, such as 5 mm, 2 mm, 1 mm or less, or a ratio of dimensions. Features of less than the threshold size may also be referred to as small features. In this example method 300, the specific print mode may comprise an amount of a detailing agent to be applied for producing the small features. The specific print mode may for example deposit additional detailing agent than a standard print mode when producing the small features. Providing additional detailing agent for small features may for example protect them from overheating, enabling them to be formed as intended.

In some examples, the threshold size may be derived from the minimum feature size which can be generated by the 3D printing system. In some examples, the threshold size may be relative to a resolution with which one or more of build material and print agents may be deposited onto the build material. In some examples the threshold size may be related to the temperature that the feature may reach when energy is applied without over melting. In some examples, a threshold size may be set larger than the minimum printable feature size.

In some examples, the dimension may be one or more of a cross sectional area and a distance between opposing faces of the feature. The cross sectional area may for example be determined by analyzing a slice through the part. In some examples, the length of the feature may also be considered, for example, such that the feature has at least a threshold length, or a predetermined ratio with the cross section dimension or area.

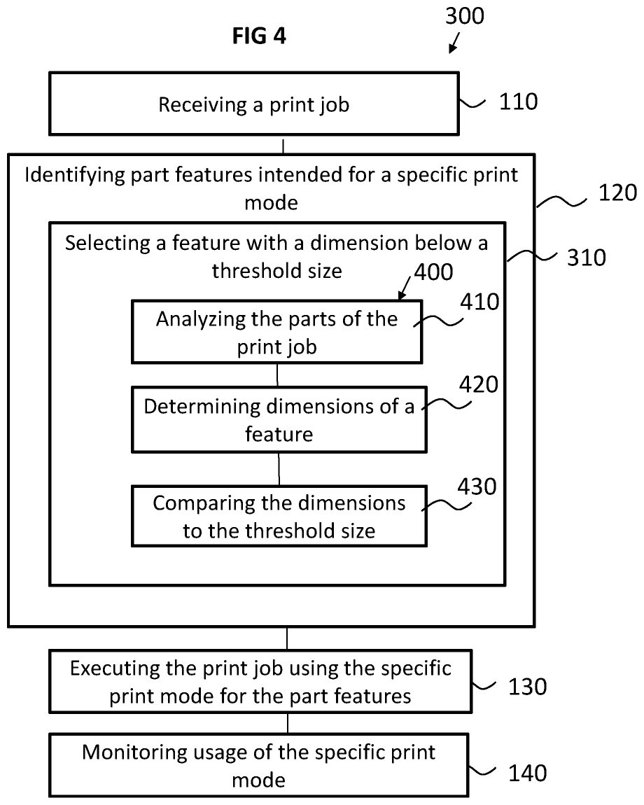

FIG. 4 illustrates an example method 400 for selecting a feature with a dimension below a threshold size. Method 400 may be implemented within block 310 of method 300.

Method 400 comprises, at block 410 analyzing the parts of the print job. Analyzing the parts of the print job may comprise searching for a feature, such as a small feature, which is intended to be printed in the specific print mode. In this example, the specific print mode may cause an increase in the amount of detailing agent applied for producing the small features.

Method 400 comprises, at block 420, determining dimensions of a feature. As mentioned above, the dimension may one or more of a cross sectional area and a distance between opposing faces of the feature.

Method 400 comprises, at block 430, comparing the dimensions determined at block 420 to the threshold size. Features below the threshold size may be selected as intended to be printed in the specific print mode.

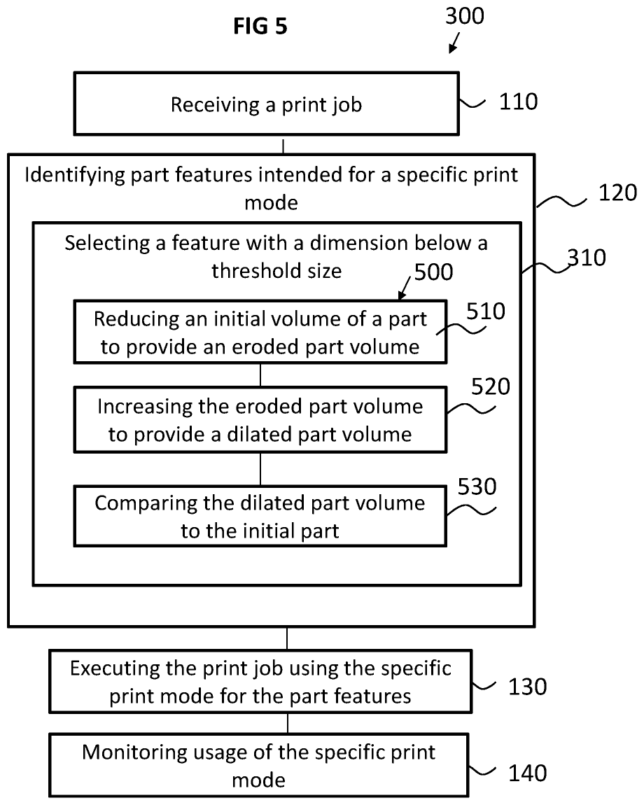

FIG. 5 illustrates another example method 500 for selecting a feature with a dimension below a threshold size. Method 500 may also be implemented at block 310 of method 300. Method 500 may be used instead of, or as well as, method 400.

Method 500 comprises, in block 510, reducing an initial volume of a part of the print job by a threshold amount in at least one spatial dimension to provide an eroded part volume. In some examples, the initial part volume is reduced by two spatial dimensions within a layer, the layer being treated as a two-dimensional plane. In other examples, the initial volume is eroded in three dimensions.

The method comprises, in block 520, increasing the eroded part volume in at least the one spatial dimension by the threshold amount to provide a dilated part volume. Features which are less than a threshold size will be completely eroded and therefore not restored by this dilatation, whereas features which are above the threshold size will be restored and may be identified.

The method comprises, in block 530, comparing the dilated part volume to the initial part and identifying differences between the dilated object volume and the initial part. The differences may be selected as features intended to be printed in the specific print mode. In some examples, any feature of a part which is present in the initial volume and absent in the dilated part volume may be selected as intended to be printed in the specific print mode.

In other examples, small features may be identified in some other way. For example, a distance between opposed faces in a mesh model of a part, or a count of voxels in a cross section of a part may be determined. In still further examples, a user may indicate on the part model that the feature is intended to be printed in the specific print mode. Combinations of these methods may be used in some examples.

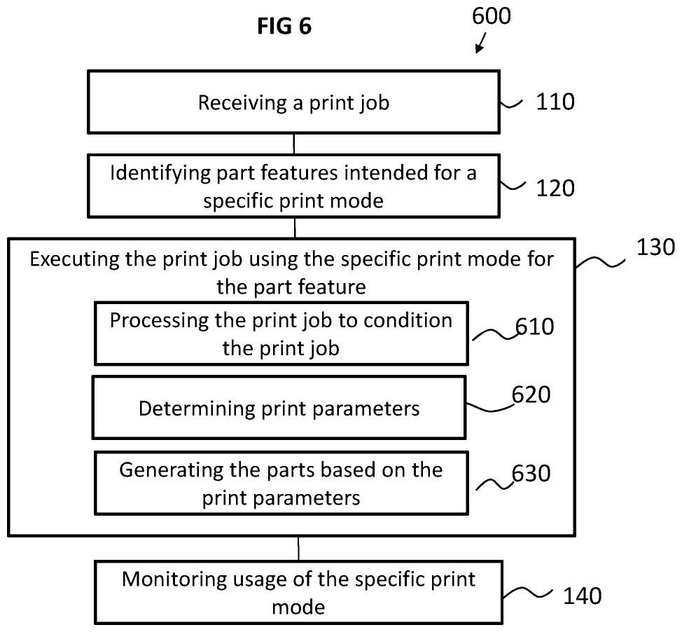

FIG. 6 illustrates another example method 600. Method 600 comprises blocks 110 to 140 as described in the context of method 100. In other example methods (not represented here), method 600 may also comprise one or more of block 210 of method 200 and block 310 of method 300.

In this example, features identified in block 120 of method 100 as features intended to be printed in the specific print mode may be one or more of small features, features intended to present a desired flexibility, a desired dimensional accuracy, a desired external surface cleanliness, a desired rugosity, a desired color and any other physical property which differs from the rest of the part.

In this example method 600, block 130 of executing the print job comprises, at block 610, processing the print job to condition the print job for production by the 3D printing system. For example, processing the print job may comprise determining ‘slices’ of a virtual build area containing the print job. The slices may refer to a digital representation of a layer of build material within a build volume. The slices may be rasterized into voxels.

Method 600 comprises, at block 620, determining print parameters, which, when operating the 3D printing system, cause the 3D printing system to generate the part. The print parameters may comprise an amount of a print agent to be selectively applied to a surface unit of a given build material layer. The amount of the print agent may be applied to each of a plurality of locations on a layer of build material. For example, an amount of print agent, or no print agent, may be associated with each of the voxels in order to specify that a print agent should be applied to a corresponding region of build material. In some examples, print parameters may comprise a distribution one or more of a fusing agent and a detailing agent to be applied on each of the plurality of locations on a layer of build material. In some examples, the print parameters may also comprise a print bed temperature, a layer thickness, a heating temperature, a build material choice, a print agent extrusion speed or another parameter that may be used by the 3D printing system to generate the parts.

The specific print mode may comprise print parameters to be used for generating the part features identified in block 120. The print parameters of the specific print mode may be different from the print parameters used for producing the rest of the part. For example, the rest of the part may be produced using a standard print mode or any other print mode. The print parameters of the specific print mode may enable the 3D printing system to achieve intended physical properties for the features identified in block 120. For example, applying an additional amount of fusing agent can increase rigidity and decrease flexibility. Conversely, a lower amount of fusing agent may result in a feature having a relatively high flexibility. Further, an additional amount of detailing agent may improve the generation of small features. Further still, modifying the distribution of print agents on the build material may help controlling layer surface temperature homogeneity, resulting in better part quality attributes. Any other of the parameters mentioned above and used by the 3D printing system may be modified in the specific print mode.

In some examples, the specific print mode may comprise additional parameters, which, when operating the 3D printing system, reconfigure the part features identified in block 120. In some examples, a layer or a portion of a layer corresponding to a part feature intended for the specific print mode may be eroded or dilated to improve dimensional accuracy. In some examples, reconfiguring the parts may improve dimensional accuracy in three dimensions. In some examples, the orientation and positioning of the part may be modified.

The method 600 comprises, at block 630 generating the parts based on the print parameters for generating the part features. For example, this may comprise forming a layer of build material, applying print agents, for example through use of ‘inkjet’ or ‘piezoelectric’ liquid distribution technologies in locations specified in a slice corresponding to that layer, and applying energy, for example heat, to the layer. A further layer may then be formed, and the process repeated. When a layer, or a portion of a layer, is relative to a feature intended for the specific print mode, the 3D printing system may modify the print parameters to those comprised in the specific print mode. When other layers, or portions of a layer, are relative to other features, another print mode may be used, such as a standard print. The 3D print mode may alternate between the specific print mode and the standard print mode. The specific print mode may comprise a first set of print parameters to operate the 3D printing system when producing the features and the standard print mode may comprise a second set of print parameters for operating the 3D printing system when producing the rest of the print job.

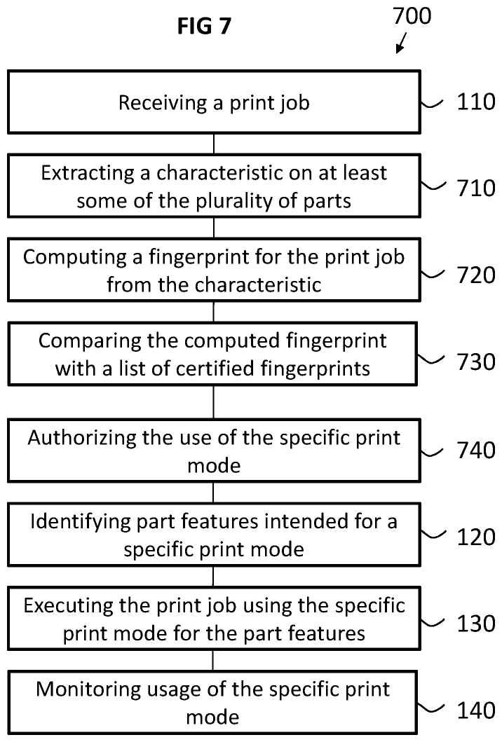

FIG. 7 illustrates another example method 700. Method 700 comprises blocks 110 to 140 as described in the context of method 100. Method 700 may be implemented to identify print jobs sent to the 3D printing system, for example to control the use of the specific print mode. Method 700 can enable univocally recognizing identical print jobs. Thus, if a print job is repeatedly sent to the 3D printing system, it may be identified and authorized to use the specific print mode.

The method 700 comprises, at block 710, extracting a characteristic on at least some of the plurality of parts. A characteristic may refer to information relative to the parts of the print job. In an example, a characteristic may be extracted for some of the parts. Limiting the number of parts for which a characteristic is extracted may improve the time used for the extraction. Alternatively, a characteristic may be extracted for all the parts to improve the accuracy and precision of the identification. For example, two print jobs comprising similar parts may be distinguished from one another. The number of parts for which a characteristic is extracted may be chosen to balance the precision of the identification with the time of the extraction.

The method 700 further comprises, at block 720, computing a fingerprint for the print job from the characteristic. The fingerprint should be understood as a specific reduced data set which permits identifying a specific larger data set. A fingerprint may for example refer to a sequence of bytes representative of the characteristic. The fingerprint therefore carries the characteristic extracted at block 710, and may define the print job. The fingerprint may be unique to the print job, but two copies of the same print job may have the same fingerprint.

The method 700 also comprises, at block 730, comparing the computed fingerprint with a list of certified fingerprints. Comparing the computed fingerprint to the list of certified fingerprint enables the print job to be recognized as a certified print job. The list of certified print job may be provided by an operator overseeing the operation of the 3D printing system. The list of certified fingerprints may for example be stored in a memory of the 3D printing system. The list of certified fingerprints may be updated by an authorized operator.

The method 700 also comprises, at block 740, authorizing the use of the specific print mode when the computed fingerprint is found in the list of certified fingerprint. Print jobs authorized to use the specific print job may be print jobs that use a known amount of time or resources, provide one or more of a suitable part yield and of a suitable part quality. In some examples, any changes to the print job, such as a change in parts or a change in the arrangement of parts, may be prevented from using the specific print mode. The print job may be specific to authorized print jobs, and the management of the 3D printing system may be improved.

In other example methods (not illustrated here) comprising blocks 710, 720, 730 and 740, such other example methods may also comprise one or more of block 210 of method 200, block 310 of method 300 and blocks 610 to 630 of method 600.

In the following paragraphs, example characteristics which may be extracted at block 710 of method 700 are discussed in further detail.

The characteristic extracted at bock 710 may comprise at least one part descriptor, wherein a part descriptor is relative to individual parts of the at least some of the plurality of parts of the print job. In other words, part descriptors may be independent of the other parts of the print job. Part descriptors may describe one or more of the general shape, structure and orientation of the part. Thus, part descriptors, based on the parts of the print job, which may also be characterized by elements of a 3D objects to be generated, are suitable for determining whether two print jobs comprise the same parts or different parts.

In some examples, the part descriptor is chosen from a list comprising: centroid coordinates of the part, information relative to a bounding box enclosing the part, information relative to the shape of the part, information related to a mesh defining the outer surface of the part, and a name of the part. The centroid coordinates of the part may refer to the group of numbers indicating the position of the centroid of the part in the print job. Information relative to a bounding box may be the minimum and maximum coordinates of the bounding box, or a point and a vector defining the orientation of the bounding box enclosing the part within a minimum volume. Information relative to the shape of the part may one or more of an overall surface area of the part, a volume of the part, a convex hull surface of the part, a volume of the part as defined by the convex hull surface. Information related to the mesh defining the outer surface of the part may be one or more of a number of elements forming the mesh, such as triangles, tetrahedrals, polygons or any other geometric shape, a number of edges comprised in the mesh and a number of vertices comprised in the mesh. The name of the part may be the name assigned to the part by the CAD application where the part was designed.

Part descriptors may also be computed from a combination of other part descriptors. A part descriptor may be a dimensionless number calculated from part descriptors relative to the shape of the part. For example, the part descriptor may be the Euler characteristic number of the part. A part descriptor may also be the density of the part, calculated as the ratio between the volume of the part with respect to the volume defined by the convex hull surface.

The characteristic extracted at bock 710 may comprise a job descriptor, wherein a job descriptor is dependent on a combination formed by at least some of the plurality of parts. Job descriptors are dependent on a combination formed by at least some of the plurality of parts comprised in the print job. Thus, job descriptors are suitable for determining whether two print jobs carry the same parts.

In some examples, the job descriptor is chosen from a list comprising: a total number of parts, a packing density of parts, a total number of layers, and a name of a print job. The total number of parts may be the number of parts comprised in the print job. The packing density may be that of formed by some or all of the plurality of parts. Packing density may be calculated as a ratio between the volume occupied by the parts with regard to the build area. The total number of layers may refer to the number of layers which the 3D printing system will use to produce the job. The name of the print job may be assigned by the CAD application used when forming the print job.

The characteristic extracted at block 710 may comprise any number of one or more of part and job descriptors. The number of one or more of part and job descriptors may be chosen to balance the speed of the extraction with the precision of the characteristic.

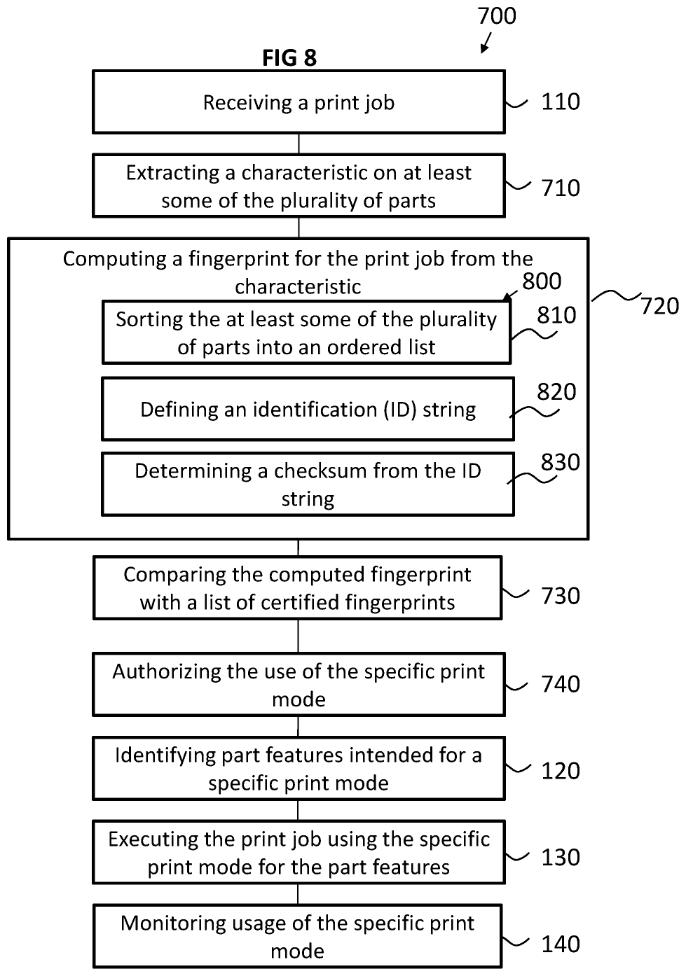

FIG. 8 illustrates an example method 800 for computing the fingerprint. Method 800 may be implemented within block 720 of method 700.

Method 800 comprises, at block 810, sorting the at least some of the plurality of parts into an ordered list. The parts sorted into the ordered list may be the parts for which a characteristic was extracted in block 710. The ordered list may be the same for identical print jobs. In some examples, identical print jobs are print job comprising the same parts. In some examples, identical print job also have the same arrangement of parts on the print bed.

In some examples, sorting the parts may comprise ordering the parts according to ascending or descending order of size. For example, the parts may be ordered according a first dimension (Z), then according to a second dimension (Y), then according to a third dimension (X). The first dimension may for example be a height of the part, and the second and third dimensions may respectively be a width and a length of the part. Such a sequenced ordering enables parts with the same size in the first dimension to be differentiated and fitted into the ordered list. In other examples, sorting the parts may comprise ordering the parts according to their arrangement on the print bed. For example, the parts may be ordered according to their position from left to right, then according to their position from top to bottom on the print bed. Thus, print jobs comprising copies of a same part may be sorted into the ordered list based on their different positions on the print bed. Any other method for sorting the parts into an ordered list may also be considered.

Method 800 comprises, in block 820, defining an identification (ID) string. Defining the ID string may comprise concatenating the characteristic on the at least some of the plurality of parts following the ordered list determined in block 810. The ID string carries the characteristics in the order defined by the ordered list. Thus, the ID string may define the print job, and may be the same for identical print jobs, regardless as to whether the print job is an original print job or a copy of the original print job.

Method 800 comprises, in block 830 determining a checksum from the ID string. The checksum may be determined by hashing the ID string. Thus, the ID string of different print jobs may be expressed as a fixed length string. For example, print jobs comprising one or more of different numbers and sizes of parts may be expressed as a same length string. Comparing the fingerprint with the list of certified fingerprints may be facilitated when the fingerprint is in the form of the checksum, improving the accuracy and speed of the comparison. Hashing may for example be achieved by a Message Digest Algorithm 5 (MD5), wherein the checksum of the ID string is an MD5 checksum (a 128-bit hash value).

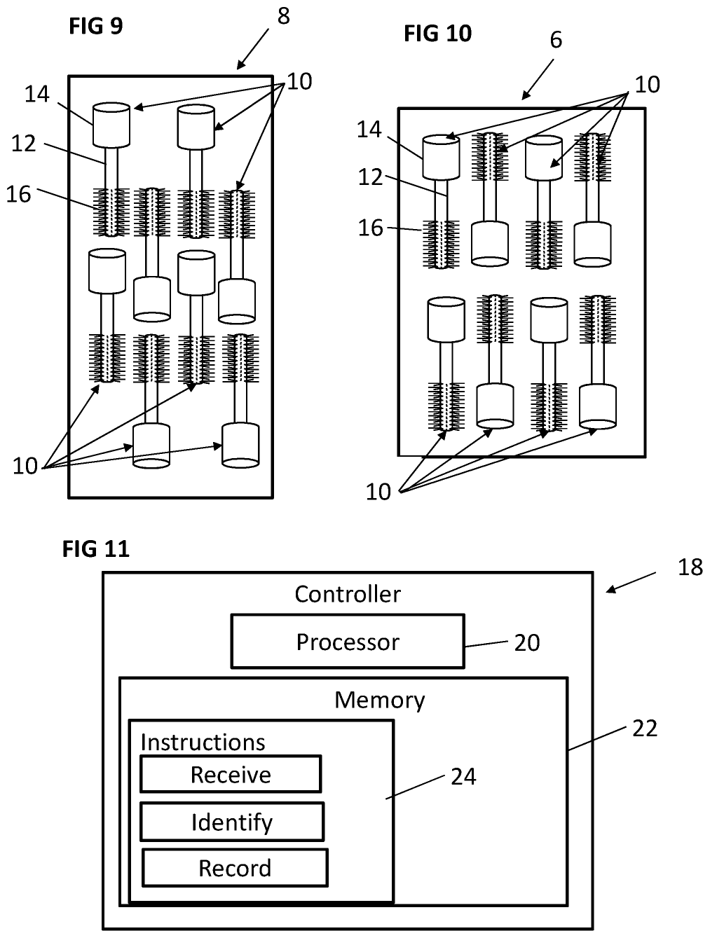

FIG. 9 depicts an example of a print job 8 received as per, for example, block 110 and executed as per, for example, block 130 of any of the example methods hereby described. In this example, the plurality of parts is a plurality of brushes 10. In some examples the brushes 10 may be used for application of cosmetics, such as mascara. In other examples, the parts may be a different type of brush such as a toothbrush or hairbrush, or a brush for use in a machine.

Each of the brushes 10 comprises a plurality of features. In this example each brush comprises a shaft 12, a handle 14 and a plurality of bristles 16. Each brush 10 comprises features greater than the threshold size, in this example the handle 14 and the shaft 12. Each brush 10 also comprises features smaller than the threshold size, in this case each of the plurality of bristles 16.

The print job 8, comprising the plurality of brushes 10, may be received by an example 3D printing system as a print job to be executed. The bristles 16 may be identified as features intended to be printed in a specific print mode. For example the cross-sectional diameter or area of a bristle may be compared to a threshold, and the bristle may be selected if the diameter or area is less than the threshold. In some examples, a model of the brush 10 may be eroded and dilated to identify the bristles 16 as less than the threshold. In some examples, a user may indicate on the part model that the bristles 16 are small features, or any other method may be used to identify the bristles.

The example 3D printing system may produce the brushes 10 by executing the print job 8, using the specific print mode for the bristles 16. For example, the specific print mode may comprise an amount of a print agent to be used by the 3D printing system for the bristles 16. Using the specific print mode for the bristles 16 may for example provide the bristles 16 with a desired flexibility. Each time a brush 10 is printed using the specific print mode for the bristles 16, the example 3D printing system may store, for example in a memory of the 3D printing system, that the specific print mode has been used. The total number of brushes 10 produced using the specific print mode may be accounted for.

In some examples, the plurality of brushes 10 may be a “production print job”, wherein a high number of brushes 10 are intended to be produced by the 3D printing system. A high number of brushes 10 may for example be more than 10 brushes, more than 100 brushes, more than 1 000 brushes or more than 10 000 brushes. In such cases, the print job 8 may be repeatedly received by the 3D printing system. The 3D printing system may identify the print job 8 as the “production print job” intended to be printed.

In such examples, the fingerprint of the print job 8 may be computed, for example as per method 700 described herein. A characteristic may be extracted, for example the centroid coordinates of each brush 10 of the print job 8. In this example, the print job 8 comprises a plurality of the same brushes 10, and an ordered list of parts may be defined according to the position of parts in the print job 8. For example, the top left brush may be the first in the ordered list while the bottom right brush may be the last in the ordered list. An ID string may be formed, comprising the centroid coordinates of each brush 10 from the top left brush to the bottom right brush. In some examples, the checksum of the ID string may be computed.

The fingerprint of the print job 8 may be compared to a list of certified fingerprints. In this example, the print job 8 may be an authorized print job, wherein 3D printing system is authorized to use the specific print mode for producing the brushes 10. The fingerprint for the print job 8 may therefore be found in the list of certified fingerprints. Each time the print job 8 is sent to the 3D printing system, the fingerprint of the print job 8 may be recognized as a certified fingerprint and authorized to be executed using the specific print mode.

FIG. 10 depicts another example print job 6 received as per, for example, block 110 and executed as per, for example, block 130 of any of the example methods hereby described. In this example, the arrangement of the plurality of brushes 10 in the print job 6 is different to that of the print job 8 illustrated in FIG. 9. In this example, the bristles 16 of two adjacent brushes 10 are oriented in opposing directions, so that the bristles 16 of adjacent brushes are not close to each other. As a result, the voxels pertaining to features intended for the specific print mode are dispersed. When executing the print job 6, the 3D printing system may frequently alternate between print modes while forming each layer. Thus the arrangement of the plurality of parts in the print job 6 is different from the arrangement of the plurality of parts in print job 8 illustrated in FIG. 9, and the print job 6 may use one or more of more time and more resources when produced by the 3D printing system than the print job 8 of FIG. 9. Other examples of print jobs which may be received by the 3D printing system may be print jobs comprising different parts, different numbers of parts or different orientation of parts compared to print job 8 of FIG. 9.

In such examples, the fingerprint of the print job 6 may differ from the fingerprint of the print job 8 illustrated in FIG. 9. For example, the centroid coordinates of each part of the print job 6 may differ from those of print job 8. In some examples, the different fingerprint may not be found in a list of certified fingerprints, and a print job may be prevented from using a specific print mode.

Any of the example methods hereby described may be implemented on a 3D printing system controller 18, which is illustrated in more detail on FIG. 11. Example printing system controller 18 comprises a processor 20, a storage medium 22 coupled to the processor 20 and an instruction set 24 to cooperate with the processor 20 and the storage medium 22.

The processor 20 may be a central processing unit. In an example, the processor 20 comprises an electronic logic circuit or core and a plurality of input and output pins for transmitting and receiving data.

The storage medium 22 may include any electronic, magnetic, optical, or other physical storage device that stores executable instructions. Storage medium may be, for example, Random Access Memory (RAM), an Electrically-Erasable Programmable Read-Only Memory (EEPROM), a storage drive, an optical disk, and the like. Data storage is coupled to the processor.

The instruction set 24 cooperates with the processor and the storage medium. In an example, instruction set 24 comprises executable instructions for the processor 20, the executable instructions being encoded in the storage medium 22. In some examples, the instruction set 24 cooperates with the processor 20 and the storage medium 22 to receive a print job, the print job comprising a plurality of parts to be generated by a three dimensional printing system, identify a part feature intended to be generated in a specific print mode, wherein the specific print mode is tailored for the part feature, execute the print job utilizing the specific print mode for the part feature and record the utilization of the specific print mode.

The present disclosure also relates to a non-transitory machine-readable or computer readable storage medium. An example of computer readable storage medium is storage medium 22. The computer readable storage medium is encoded with instructions comprised in the instructions set 24 and executable by a processor such as processor 20. The instructions, when executed, direct the processor to receive a print job, the print job comprising a plurality of parts to be produced by a three dimensional printing system, find a part feature intended to be produced in a specific print mode, wherein the specific print mode is designed for the part feature, carry out the print job using of the specific print mode for the part feature and keep track of the usage of the specific print mode.

1. A method implemented in a three dimensional printing system comprising:
receiving a print job, the print job comprising a plurality of parts to be printed by the three dimensional printing system;
identifying a part feature intended to be printed in a specific print mode, wherein the specific print mode is customized for the part feature;
executing the print job using the specific print mode for the part feature;
monitoring the usage of the specific print mode.

2. The method according to claim 1, wherein monitoring the usage of the specific print mode comprises determining a number of parts comprising a part feature intended to be printed in the specific print mode.

3. The method according to claim 1, wherein identifying the part feature comprises selecting a feature with a dimension below a threshold size.

4. The method according to claim 3, wherein the dimension is one or more of a cross sectional area and a distance between opposing faces of the feature.

5. The method according to claim 1, wherein the specific print mode comprises print parameters for generating the part feature.

6. The method according to claim 5, wherein the print parameters comprise an amount of a print agent to be applied to a build material when generating the part feature.

7. The method according to claim 1, comprising identifying the print job, wherein identifying the print job comprises:
extracting a characteristic on at least some of the plurality of parts,
computing a fingerprint for the print job from the characteristic;
comparing the computed fingerprint to a list of certified fingerprints; and
authorizing the use of the specific print mode when the computed fingerprint is found in the list of certified fingerprints.

8. The method according to claim 7, wherein the characteristic comprises at least one part descriptor, wherein the part descriptor is relative to individual parts of the at least some of the plurality of parts.

9. The method according to claim 8, wherein the part descriptor is chosen from a list comprising: centroid coordinates of the part, information relative to a bounding box enclosing the part, information relative to the shape of the part, information related to a mesh defining the outer surface of the part, and a name of the part.

10. The method according to claim 7, wherein the characteristic comprises at least one job descriptor, wherein the job descriptor is dependent on a combination formed by the at least some of the plurality of parts.

11. The method according to claim 10, wherein the job descriptor is chosen from a list comprising: a total number of parts, a packing density of parts, a total number of layers, and a name of the print job.

12. The method according to claim 7, wherein computing the fingerprint comprises:
sorting the at least some of the plurality of parts into an ordered list;
defining an identification string, wherein defining the identification string comprises
concatenating the characteristic on the at least some of the plurality of parts following the ordered list; and
determining a checksum from the identification string.

13. The method according to claim 1, wherein the plurality of parts is a plurality of brushes, and the feature is a bristle of the brush.

14. A printing system controller comprising a processor, a storage medium coupled to the processor and an instruction set to cooperate with the processor and the storage medium to:
receive a print job, the print job comprising a plurality of parts to be generated by a three dimensional printing system;
identify a part feature intended to be generated in a specific print mode, wherein the specific print mode is tailored for the part feature;
execute the print job utilizing the specific print mode for the part feature;
record the utilization of the specific print mode.

15. A computer-readable storage medium storing instructions that, when executed, direct a processor to:
receive a print job, the print job comprising a plurality of parts to be produced by a three dimensional printing system;
find a part feature intended to be produced in a specific print mode, wherein the specific print mode is designed for the part feature;
carry out the print job using of the specific print mode for the part feature;
keep track of the usage of the specific print mode.
